(19) United States
(12) Patent Application Publication
(10) Pub. No.: US 2024/0163362 A1
(43) Pub. Date: May 16, 2024

(54) METHOD FOR MODIFYING A PARAMETER OF A FIRST DEVICE, AND ELECTRONIC DEVICE ASSOCIATED THERETO

(71) Applicant: Orange, Issy-les-Moulineaux (FR)

(72) Inventors: Chantal Guionnet, CHATILLON CEDEX (FR); Jean-Bernard Leduby, CHATILLON CEDEX (FR)

(21) Appl. No.: 18/504,976

(22) Filed: Nov. 8, 2023

(30) Foreign Application Priority Data
Nov. 14, 2022 (FR) 2211824

(51) Int. Cl. H04M 1/72454; H04M 1/72463; H04M 1/72484

(52) U.S. Cl. CPC H04M 1/72454; H04M 1/72463; H04M 1/72484

(57) ABSTRACT

A method for modifying a value of at least one parameter of at least one first device is described. The method includes obtaining a current activity of a first user depending on data representative of the behavior of the user in an environment including at least one connected object, the data being captured by the at least one connected object. The method also includes transmitting an instruction aimed at modifying the value of the at least one parameter of the at least one first device, depending on the activity obtained.

### TECHNICAL FIELD

The disclosed technology belongs to the general field of telecommunications. It relates more particularly to a method for modifying the value of a parameter of a device of a user. It also relates to an electronic device configured to implement such a method. The disclosed technology finds a particularly advantageous application, although without limitation, when the user is located in a smart environment in which connected objects (Internet Of Things) are installed.

### Discussion of Related Technology

Conventionally, the parameters notifying the receipt of a phone call, a message, or a message generated by an application are managed manually by the phone user. Thus, if the user of a mobile phone participates in a meeting, he typically activates a mode called “silent” mode on his phone. However, in such a situation, the phone user must make sure to manually modify these significance parameters. In case he forgets, this user runs the risk of having his phone ringing during the meeting.

There is therefore a need for a solution to automatically adapt the parameters of a device of a user, such as a mobile phone, depending on the activity of a user, thus improving the experience of the user of such a device.

### SUMMARY

The disclosed technology aims to overcome all or part of the drawbacks of existing approaches, in particular those set out above, by proposing a solution to automatically adapt the parameters of the device of a user, depending on the activity of this user.

More particularly, the disclosed technology makes it possible to automatically adapt the parameters of a device, such as a communication device which can for example take the form of a mobile phone, depending on the activity of a user.

For this purpose, and according to a first aspect, the disclosed technology relates to a method for modifying a value of at least one parameter of at least one first device, the method comprising:
obtaining a current activity of a first user depending on data representative of the behavior of the first user in an environment including at least one connected object, the data being captured by the at least one connected object; and,
transmitting an instruction aimed at modifying the value of the at least one parameter of the at least one first device, depending on the activity obtained.

Within the meaning of the disclosed technology, an “activity” is characterized by a set of elementary events which are at least partly time-ordered. These elementary events describe the gestures, actions and/or interactions of one or more users, and are determined based on data from connected objects. “Cooking”, “Starting a course or a meeting” are examples of activities.

Within the meaning of the disclosed technology, the “data representative of the behavior of a user” refer to these elementary events.

Within the meaning of the disclosed technology, “gesture” means an elementary movement of part of the human body, such as “raising the hand” or “lowering the head”.

Within the meaning of the disclosed technology, “action” means an elementary activity of a user composed of a set of gestures temporally organized, such as “walking”, “speaking”, “drinking”, “sitting”, “accessing”, “opening”.

Within the meaning of the disclosed technology, “interaction” means a human activity which involves several persons, for example two persons talking to each other or two persons looking at the same document.

Within the meaning of the disclosed technology, “connected object” means an electronic device configured to transmit data. The notion of connected object includes:
the sensors configured to transpose a physical measurement, such as the temperature or a movement into a digital data;
the actuators configured to generate an action and transmit, in response to the generated action, information characterizing this action. Triggering an alarm, activating/deactivating a motor, using switches or light dimmers are examples of actions that can be generated by an actuator;
an object called “smart” object, that is to say equipped with data processing and analysis capabilities, even with the ability to communicate with another electronic device or with a dedicated infrastructure, such as a data collection and processing platform.

In particular implementations, the activity of the first user is determined by application of a neural network on the data representative of the user's behavior, these data being captured by at least a first connected object of a first type and a second connected object of a second type.

It is also important to note that the step of obtaining a current activity comprises determining, by the device implementing this obtaining step, the current activity. As a variant, the step of obtaining a current activity comprises receiving, by the device implementing this obtaining step, a current activity determined by another device.

Generally, it is considered that the steps of a method should not be interpreted as being related to a notion of temporal succession.

In particular implementations, the method according to the disclosed technology can also include one or more of the following characteristics, taken separately or in all technically possible combinations.

In particular implementations, the method further comprises receiving the data representative of the behavior of the first user, and the step of obtaining an activity of the first user comprises determining the at least one activity.

In particular implementations, the method according to the disclosed technology further comprises a step of identifying the at least one first device and/or of obtaining means for accessing said at least one first device.

In particular implementations, the method further comprises determining a value of at least one parameter of the at least one first device to be modified.

In particular implementations, the at least one parameter of the device is a parameter representative of an interaction modality.

Within the meaning of the disclosed technology, an “interaction modality” characterizes the exchanges between an electronic device and its user. More specifically, modifying the value of the parameter aims for example to modify the parameters notifying the receipt of a call or a message, by adapting the volume of the ringtone, by activating/deactivating a “vibrate” mode, and/or by activating or deactivating a mode called “silent” mode, by adapting the presentation (e.g., the display) of a data on the screen of the electronic device.

In particular implementations, the method according to the disclosed technology further comprises obtaining a current value of the at least one parameter of the first device, and the transmission step is triggered if the current value obtained is different from the determined value.

This characteristic is advantageous since it triggers the transmission of data only when a change is determined, so as to limit the amount of messages transmitted between the different devices composing the system according to the disclosed technology.

In particular implementations, the method according to the disclosed technology further comprises:
obtaining a current activity of at least one second user different from the first user, the activity of the at least one second user being determined depending on data representative of the behavior of the second user in the environment; and,
and the value of at least one parameter of the first device to be modified is determined depending on the activity of the at least one second user.

This characteristic is advantageous since the value of the parameter is determined depending on the activity of the first and at least one second users. In one particular example, the electronic device is that of the first user, and a modality of interaction between this electronic device and the first user is determined depending on the activity of a second user located in the immediate vicinity of the first user.

In particular implementations, the instruction is transmitted to a plurality of first devices located at a predetermined distance from the first user.

In particular implementations, the instruction is transmitted to a mobile device of the first user.

In particular implementations, the transmitted instruction comprises a data representative of a duration during which the at least one parameter of the at least one first device must consider the modified value.

In particular implementations, the method according to the disclosed technology is implemented by a second device different from the first device, such as a gateway, and the instruction aimed at modifying the value of at least one parameter of the first device is transmitted by the second device and to the first device.

In particular implementations, the transmission is triggered in response to the receipt, by the second device, of a verification request coming from the first device.

In particular implementations, the method according to the disclosed technology is implemented by the mobile device of the user, and the step of transmitting an instruction aimed at modifying the value of at least one parameter of the device is implemented within said mobile device.

According to a second aspect, the disclosed technology relates to an electronic device configured to modify a value of at least one parameter of at least one first device, and comprising:
a module for obtaining an activity of a first user depending on data representative of the behavior of the user in an environment including at least one connected object, the data being captured by the at least one connected object; and,
a module for transmitting an instruction aimed at modifying the value of the at least one parameter of the at least one first device, depending on the activity obtained.

According to a third aspect, the disclosed technology relates to a computer program including instructions for the implementation of a method according to the disclosed technology, when said program is executed by a processor.

According to a fourth aspect, the disclosed technology relates to a computer-readable recording medium on which the computer program according to the disclosed technology is recorded.

### BRIEF DESCRIPTION OF THE DRAWINGS

Other characteristics and advantages of the disclosed technology will emerge from the description given below, with reference to the appended drawings which illustrate one exemplary embodiment devoid of any limitation. In the figures:

FIG. 1A schematically represents an exemplary embodiment in accordance with the disclosed technology, of a system 1000 comprising a home gateway 100 configured to modify a parameter of a mobile device 200 of a user, depending on the activity of this user;

FIG. 1B schematically represents another exemplary embodiment in accordance with the disclosed technology, of a system 1000 comprising a remote server 400 and of a mobile device 200 of a user.

FIG. 2 schematically represents an exemplary embodiment, in accordance with the disclosed technology, of an electronic device configured to modify a parameter of a first device;

FIG. 3 schematically represents an example of hardware architecture of an electronic device configured to modify a parameter of a first device;

FIG. 4A represents, in the form of a flowchart, a first example of a method for modifying a parameter, in accordance with the disclosed technology;

FIG. 4B represents, in the form of a flowchart, a second example of a method for modifying a parameter, in accordance with the disclosed technology;

FIG. 4C represents, in the form of a flowchart, a third example of a method for modifying a parameter, in accordance with the disclosed technology; and

FIG. 4D represents, in the form of a flowchart, a fourth example of a method for modifying a parameter, in accordance with the disclosed technology.

### DETAILED DESCRIPTION

Unless otherwise indicated, the elements common or similar to several figures bear the same reference signs and have identical or similar characteristics, so that these common elements are generally not described again for the sake of simplicity.

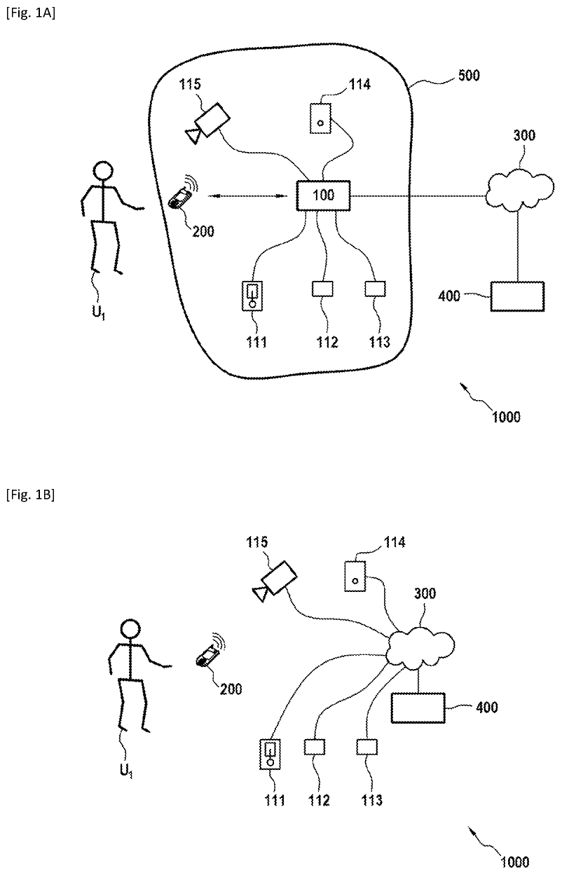

FIG. 1A schematically represents an exemplary embodiment in accordance with the disclosed technology, of a system 1000 comprising a home gateway 100 configured to modify a parameter of a mobile device 200 of a user, depending on the activity of this user.

As illustrated in FIG. 1A, the system 1000 comprises a home gateway 100. A home gateway is network termination equipment and is often called “box”, CPE (initials of “Customer Premises Equipment”), or HG (initials of “Home Gateway”). Its main role is to establish and manage the connection between a Local Area Network and a telecommunications network (also commonly called “access network”, “Wide Area Network”), such as the Internet. Typically, a home gateway integrates a router, a wireless network access point, a switch and a modem.

The home gateway 100 is configured to administer a local area network 500, for example within a dwelling, which comprises a set of objects connected to this home gateway 100 through a wired or non-wired connection.

It is recalled here that within the meaning of the disclosed technology, “connected object” means an electronic device configured to transmit data. The notion of connected object includes:
the sensors configured to transpose a physical measurement, such as the temperature or a movement into a digital data;
the actuators configured to generate an action and transmit, in response to the generated action, information characterizing this action. Triggering an alarm, activating/deactivating a motor, using switches or light dimmers are examples of actions that can be generated by an actuator;
an object called “smart” object, that is to say equipped with data processing and analysis capabilities, even with the ability to communicate with another electronic device or with a dedicated infrastructure, such as a data collection and processing platform.

These connected objects take for example the form of a door opening and closing actuator 111, of a presence detector 112, of a light dimmer 113, of a sound sensor 114 and of a video surveillance camera 115.

These connected objects transmit the collected data to the gateway 100 through the local area network 500.

In this example, the home gateway 100 is configured in hardware and software to implement a modification method according to the disclosed technology. More particularly, the home gateway 100 is configured to communicate with the mobile device 200 of a user U 1. For this, the user's device 200 is connected to the local area network 500 administered by the home gateway 100, for example through a local Wi-Fi network administered by the home gateway installed within the user's U 1 dwelling.

As a variant, the home gateway 100 and the mobile device 200 of the user communicate with each other through a telecommunications network 300, such as the Internet. As a variant, the home gateway 100 communicates with a remote server 400, for example administered by a telecommunications network manager, through a first network (for example the telecommunications network 300), and the remote server 400 communicates with the mobile device 200 of the user through a second telecommunications network (for example a cellular network such as a mobile network (e.g. 3G, 4G, 5G, etc.), WiMAX, etc.).

The case where a single device 200 of a user U 1 is taken into account in the system 1000 is considered here without limitation. The disclosed technology nevertheless remains applicable for a plurality of user devices present in an environment.

The device 200 of a user corresponds for example to a cellular phone, for example of the Smartphone type, a touchscreen tablet, a personal digital assistant, a personal computer, etc. Generally, no limitation is attached to the nature of said user's device 200. Moreover, said user's device 200 can occupy a fixed position or be mobile, the disclosed technology applying indifferently to either of these configurations.

The user's device 200 is located at a distance from the user which is smaller than a predetermined threshold value (for example 4 meters). It should also be noted that this threshold value can be defined according to the size of the environment in which the disclosed technology is implemented, and/or according to the considered activities.

This system 1000 is installed within an environment, preferably inside a building. This is for example a meeting room, an amphitheater, a theater, a cinema, or a dwelling.

FIG. 1B schematically represents another exemplary embodiment in accordance with the disclosed technology, of a system 1000 comprising a remote server 400 and of a mobile device 200 of a user.

Unlike FIG. 1A, the connected objects 111, 112, 113, 114 and 115 no longer transmit the data collected to a domestic gateway 100, but directly to the remote server 400, through a telecommunications network 300. To transmit these data, the connected objects 111, 112, 113, 114 and 115 use for example Bluetooth Low Energy (BLE), Wi-Fi, RFID, Radio Frequency (RF), cellular connections (from 2G to 5G), LPWAN networks or satellite.

In this example, the remote server is configured in hardware and software to implement a modification method according to the disclosed technology, and in particular to transmit to the mobile device 200, an instruction aimed at modifying the value of a parameter of the mobile device 200.

Alternatively, it is the mobile device 200 that is configured in hardware and software to implement a modification method according to the disclosed technology, and in particular to transmit to a module of said device able to adapt an interaction modality of this device, an instruction aimed at modifying the value of a parameter.

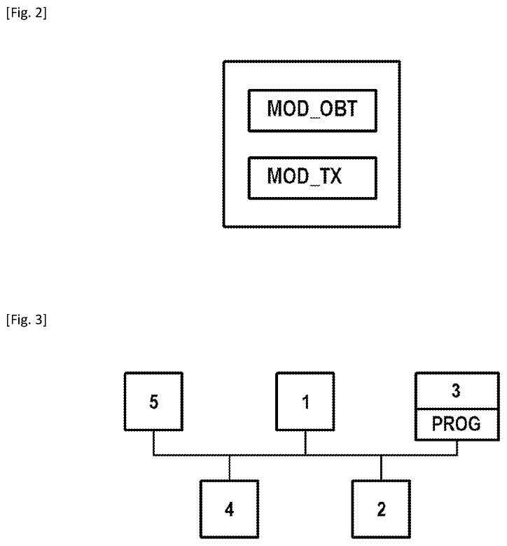

FIG. 2 schematically represents an exemplary embodiment, in accordance with the disclosed technology, of an electronic device configured to modify a parameter of a user's device.

This electronic device corresponds for example to a gateway such as the domestic gateway 100 of FIG. 1A, to a mobile device such as the mobile device 200 of the user U 1 of FIG. 1B, or to a remote server such as the remote server 400 of FIG. 1B.

It comprises in particular a module MOD_OBT for obtaining a current activity of a first user depending on data representative of the behavior of this user, and a module MOD_TX for transmitting an instruction whose functionalities are described below.

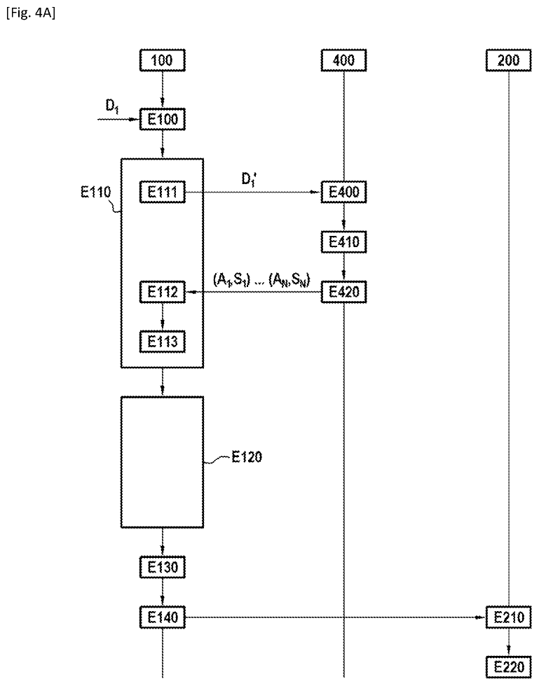

FIG. 3 schematically represents an example of hardware architecture of an electronic device configured to modify a parameter of a user's device.

As illustrated in FIG. 3, the electronic device has the hardware architecture of a computer. Thus, the electronic device includes, in particular, a processor 1, a random access memory 2, a read only memory 3 and a non-volatile memory 4. It further includes a communication module 5.

The read only memory 3 of the electronic device constitutes a recording medium as proposed, readable by the processor 1 and on which a computer program PROG in accordance with the disclosed technology is recorded, including instructions for the execution of steps of the modification method as proposed. The program PROG defines functional modules of the electronic device as represented in FIG. 2, which rely on or control the hardware elements 1 to 5 of the electronic device mentioned above, and which comprise in particular:
a module MOD_OBT for obtaining a current activity of a first user depending on data representative of the behavior of this first user in an environment including at least one connected object, the data being captured by the at least one connected object; and,
a module MOD_TX for transmitting an instruction aimed at modifying the value of the at least one parameter of the at least one first device, depending on the activity obtained.

Moreover, the electronic device can also include other modules, in particular to implement particular modes of the modification method, as described in more detail later.

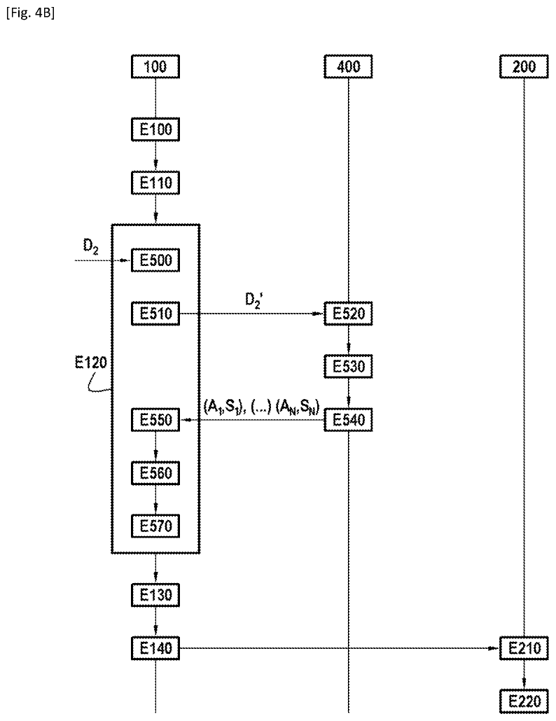

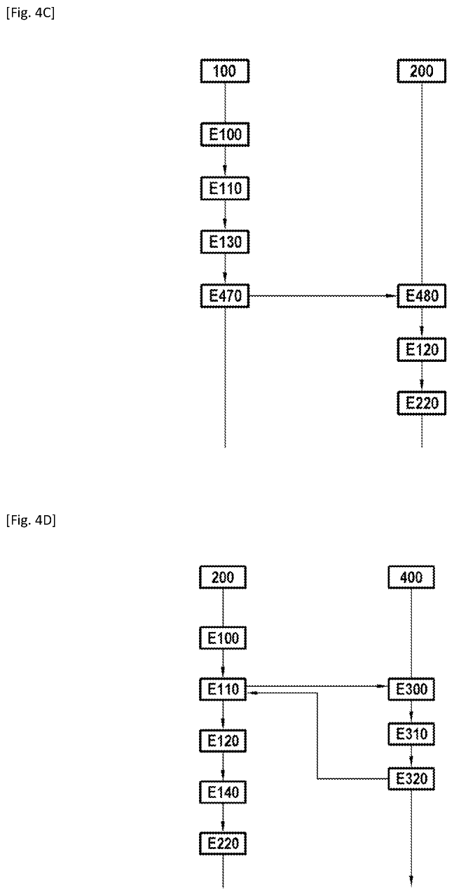

FIG. 4A represents, in the form of a flowchart, a first example of a method for modifying a parameter, in accordance with the disclosed technology.

During a first step E100, the gateway 100 obtains data D₁ captured by a plurality of connected objects of at least two types, such as the connected objects 111 to 115 of FIGS. 1A and 113. The connected objects are of at least two types in the sense that their functionalities are different. It is for example data captured by the presence detector 112 and data captured by the sound sensor 114 of FIG. 1A or 113. The captured data are representative of the behavior of a user in an environment. It is for example data representative of a gesture (or a sequence of gestures), such as “raising the hand” or “lowering the head”, of an action of a user such as “walking”, “speaking”, “drinking”, “sitting”, of a sound, of a position of this user, etc.

The modification method further comprises a step of obtaining (E110) an activity of the user determined by application of a neural network on the data D₁ or on data resulting from a first analysis of these data D₁. In this case, a first analysis is carried out by the gateway, for example to filter some values, or to identify erroneous data.

In this example, step E110 comprises the sub-steps E111, E112 and E113. The data D₁ or the data D₁′ analyzed are transmitted during a step E111 to a remote server 400, for example the server 400 of FIG. 1A or 1B, then received by this server during a step E400.

The modification method further comprises a step E410 of determining, by the remote server 400, an activity of the user. This determination step is for example implemented by application of a neural network on data representative of the behavior of the user. This neural network performs a fusion of the data received by automatically extracting characteristics from the received data, then these characteristics feed a classifier configured to associate a confidence score with at least one activity.

The details of implementation of the activity detection step E410 are for example described in the following documents: “Multimodal Deep Learning for Group Activity Recognition in Smart Office Environments”, Florea et Al., Future Internet, 2020; “Activity Recognition on Streaming Sensor Data”, Krishnan et Al., Pervasive and Mobile Computing, Volume 10, 2014″.

In this example, the classifier generates, from the data D₁′, a set of pairs (Aᵢ; Sᵢ), for i=1 N, with N a number of activities, Aᵢ an activity identification data, and sᵢ, a score associated with the activity Aᵢ. This set of pairs is transmitted by the remote server 400 during a step E420, then received by the gateway 100 during a step E112. During a step E113, the gateway selects one of the activities (Aᵢ; Sᵢ) according to its confidence score. In one particular embodiment, the gateway selects the activity with the highest confidence score.

The method further comprises a step E120 of determining a value of at least one parameter of the at least one first device to be modified, depending on the activity obtained during step E110.

In one particular embodiment, the gateway comprises an association table associating, with a given activity, a specific configuration of the device characterized by values that the parameters of the device must then take. In this case, the value of at least one parameter of the at least one first device to be modified is determined by consultation of this association table.

In one particular embodiment, this parameter is a parameter representative of an interaction modality. More specifically, the modification of the value of the parameter aims for example to modify the parameters notifying the receipt of a call or a message, by adapting the volume of the ringtone, by activating/deactivating a “vibrate” mode, and/or by activating or deactivating a mode called “silent” mode, by adapting the presentation (e.g., the display) of a data on the screen of the mobile device 200.

In one particular embodiment, step E120 further comprises a step of obtaining a current value of the at least one parameter of the first device, and the identification (E130) and transmission (E140) steps described below are triggered if the current value obtained is different from the determined value. As a variant, the identification (E130) and transmission (E140) steps are systematically triggered as soon as a new activity is detected, as soon as an end of activity is detected or as soon as a modification of activity is detected. As a variant, an application installed on the mobile device 200 regularly transmits a verification request to the gateway, and the transmission (E140) is triggered in response to the receipt, by the gateway, of this request.

The method further comprises a step E130 of identifying and obtaining means for accessing the mobile device 200 whose value of at least one parameter must be modified.

In one particular embodiment, the gateway identifies the user by analyzing the data captured by a connected object (for example by applying a facial recognition algorithm to video images captured by the video surveillance camera 115), and accesses an association table associating a user with an identifier and/or with data for access to a mobile device 200.

This identifier and/or these access data correspond for example to:
an IMEI (International Mobile Equipment Identity) number,
a serial number of the mobile device,
a serial number of the SIM card inserted or embedded in the mobile device,
a phone number,
a local IP address,
a hardware MAC (Media Access Control) address of said mobile device.

It can moreover be noted that such data may be transmitted without the user's knowledge even though no SIM card is activated by the mobile device 200.

The method further comprises a step E140 of transmitting, by the gateway 100 and to the mobile device 200, the current value of the at least one parameter determined in step E120. More specifically, a request to modify a parameter comprising an identifier of the parameter, as well as the value to be taken, is transmitted to the mobile device 200, which receives it during a step E210.

Finally, during a step E220, the mobile device applies this new value, so as to adapt the mobile device 200 to the human activity detected during step E110.

In one particular mode of implementation, this automatic setting is adjusted by the user of the mobile device 200 after the mobile device 200 has received the instruction aimed at modifying the value of one of its parameters, or set up upstream by this user, so that the mobile device 200 is not automatically updated in response to the receipt of such an instruction.

FIG. 4B represents, in the form of a flowchart, a second example of a method for modifying a parameter, in accordance with the disclosed technology.

During a first step E100, the gateway 100 obtains data D₁. The modification method further comprises a step E110 of obtaining an activity of a first user determined by application of a neural network on the data D₁ or on data resulting from a first analysis of these data D₁, and a step E120 of determining a value of at least one parameter of the at least one first device to be modified, depending on the activity obtained during step E110, as described for example with reference to FIG. 4A.

This step E120 comprises a sub-step E500 of receiving data representative of at least one second user different from the first user, these data also being captured by connected objects. These connected objects correspond to those having captured the data representative of the behavior of the first user, or to other connected objects.

There is a “dynamic link” between the users. Thus, this second user is for example located in the immediate vicinity of the first user (for example in the same room as the first user), or is physically remote from the first user but connected to a video-conferencing system allowing interaction with this first user.

These data D₂ (or the data D₂′ resulting from a first analysis of the data D₂) are transmitted by the gateway 100, during a step E510, then received by the remote server 400 during a step E520.

The modification method further comprises a step E530 of determining, by the remote server 400, an activity of the second user by application of a neural network on data representative of the user's behavior. This step is similar to step E410 previously described with reference to FIG. 4A.

In this example, the classifier generates, from the data D₁′, a set of pairs (Aᵢ; Sᵢ), for i=1 N, with N a number of activities, Aᵢ an activity identification data, and sᵢ a score associated with the activity Aᵢ. This set of pairs is transmitted by the remote server 400 during a step E540, then received by the gateway 100 during a step E550. During a step E560, the gateway selects one of the activities (Aᵢ; Sᵢ) of the second user according to his confidence score. In one particular embodiment, the gateway selects the activity with the highest confidence score.

The method further comprises a step E570 during which a value of at least one parameter of the first device to be modified is determined, depending on the activity of the first user obtained during step E110 and on the activity of the second user obtained during step E560.

As a variant, the data representative of the behavior of several second users are detected, and the value of at least one parameter of the first device to be modified is determined depending on the activity of the first user obtained during step E110 and on each of the activities of the second users obtained during step E560.

As a variant, the data representative of the behavior of several second users are detected, and the value of at least one parameter of the first device to be modified is determined depending on the activity of the first user obtained during step E110 and on an overall activity of the group of users composed of the second users. This overall activity of the group of users is for example determined by the server 400, and only one data identifying an overall activity, and possibly an associated score, are transmitted to the gateway 100 during step E540. As a variant, the server transmits, for each second user in the group, an identification data, and possibly an associated score. In the latter case, the determination of an overall activity is implemented by the gateway 100, depending on the identification data received, and possibly their associated score.

In particular implementations, the values of the activities of the second users are weighted according to their geographical proximity to the first user, or according to the very nature of their activity, during the step of determining the value of at least one parameter of the first device to be modified.

In other words, in particular implementations, the activities of the second user(s) are taken into account in the setting of the electronic device of the first user. Thus, when the first user works for example in a collective workspace in the vicinity of second users, the modality of interaction of the mobile device 200 of the first user is adapted to the context, for example by activating the “vibrate” mode.

The method further comprises a step E130 of identifying and obtaining means for accessing the mobile device 200 whose value of at least one parameter must be modified.

In one embodiment, the instruction is transmitted to the mobile device 200 of the first user, and the identification step is a step of identifying and obtaining means for accessing the mobile device 200 of the first user, as described for example with reference to FIG. 4A.

As a variant, the instruction is transmitted to the mobile device(s) 200 of the second user(s), and the identification step is a step of identifying and obtaining means for accessing the mobile device(s) 200 of the second user(s).

In one exemplary implementation, the means for accessing the mobile device(s) 200 of the second user(s) are previously stored in a database, for example populated during a session of registration to an event, and the step of identifying and obtaining access means comprises the access to this database.

As a variant, the instruction is transmitted to the mobile device 200 of the first user and to the mobile device(s) 200 of the second user(s), and the identification step is a step of identifying and obtaining means for accessing the mobile device 200 of the first user and the mobile device(s) 200 of the second user(s).

In particular implementations, the transmitted instruction comprises a data representative of the time during which the at least one parameter of the at least one first device must consider the modified value.

Thus, the manager of an environment such as a theater or an amphitheater is for example able to monitor the modalities of interaction of the users' electronic devices, but this modification is only carried out for a predetermined duration, corresponding for example to the duration of the show or the course.

In this way, as long as the actors have not started playing, the spectators have the possibility of receiving calls. When the start of the show is detected, an instruction is transmitted to the devices of the spectators so that their modality of interaction is modified for the duration of the show.

The method further comprises a step E140 of transmitting the value to be taken to the device(s) identified during step E130, which receives it during a step E210. Finally, during a step E220, the identified device(s) apply(ies) this new value, so as to adapt to the human activity detected during step E110.

FIG. 4C represents, in the form of a flowchart, a third example of a method for modifying a parameter, in accordance with the disclosed technology.

During a first step E100, the gateway 100 obtains data D₁. The modification method further comprises a step E110 of obtaining an activity of a first user determined by application of a neural network on the data D₁ or on data resulting from a first analysis of these data D₁, as described for example with reference to FIG. 4A.

The method further comprises a step E130 of identifying and obtaining means for accessing a mobile device 200 whose value of at least one parameter must be modified, as described for example with reference to FIG. 4A.

Then, during a step E470, the activity of a first user obtained during step E100 is transmitted to the mobile device 200 identified during step E130, then received by this device 200 during a step E480. As a variant, this transmission step is only triggered in response to the receipt, by the gateway, of a verification request issued by the mobile device 200.

The method further comprises a step E120 of determining, by the mobile device 200, a value of at least one parameter of the at least one first device to be modified, depending on the activity obtained during step E110, as described for example with reference to FIG. 4A. Finally, during a step E220, the mobile device applies this new value, so as to adapt to the human activity obtained during step E110.

FIG. 4D represents, in the form of a flowchart, a fourth example of a method for modifying a parameter, in accordance with the disclosed technology.

During a first step E100, the mobile device 200 obtains data D₁. The modification method further comprises a step E110 of obtaining, by the mobile device 200, an activity of a first user determined by application of a neural network on the data D₁ or on data resulting from a first analysis of these data D₁, as described for example with reference to FIG. 4A.

The method further comprises a step E120 of determining, by the mobile device 200, a value of at least one parameter of the at least one first device to be modified, depending on the activity obtained during step E110, as described for example with reference to FIG. 4A.

Then, during a step E140, an instruction aimed at modifying the value of the at least one parameter of the mobile device 200 is transmitted, within said mobile device, to a module of said device able to adapt a modality of interaction of this device.

Finally, during a step E220, the mobile device applies this new value, so as to adapt to the human activity obtained during step E110.

### Application Scenarios

### Example 1

Pierre arrives late for the meeting during which he must make a presentation. Without taking the time to set up his mobile phone in “silent” mode, he begins his presentation. His mother, always impatient, has not yet received the response to the text message she sent him yesterday. She sends him another text message, then after a few moments, decides to call him.

Fortunately for Pierre, when entering the meeting room, the gateway installed in the room detected his activity and deduced that his phone must be in “silent” mode, and transmitted an instruction to this effect to his mobile phone.

### Example 2

Jeanne arrives in an amphitheater to attend a presentation. The gateway installed in the amphitheater detects the presence of many persons settling in, and her phone activates the “vibrate” mode in response to the receipt of an instruction from the gateway. Since there is a lot of noise, the vibration will not disturb anyone until the presentation begins.

The presenter arrives, begins his presentation, he is now the only one speaking. With the detection of this new activity of the presenter, silence returns to the amphitheater, and the gateway sends to all the phones detected in the amphitheater an instruction to modify the parameters to switch to “silent” mode, and by deactivating the “vibrate” mode.

### Example 3

Rose is listening to music on headphones. A device detects her activity and deduces that she will not be able to hear the calls, so it triggers the flash of her phone's light as soon as a call is received.

Various embodiments and examples have been disclosed herein. Although the disclosed technology has been disclosed in the context of certain embodiments and examples, it will be understood by those skilled in the art that this disclosure extends beyond the specifically disclosed embodiments to other alternative embodiments and/or uses of the embodiments and certain modifications and equivalents thereof. The scope of the present disclosure is not intended to be limited by the specific disclosures of preferred embodiments in this section or elsewhere in this specification, and may be defined by claims as presented in this section or elsewhere in this specification or as presented in the future.

1. A method for modifying a value of at least one parameter of at least one first device, the method comprising:
obtaining a current activity of a first user depending on data representative of the behavior of the first user in an environment including at least one connected object, the data being captured by the at least one connected object; and
transmitting an instruction intended to modify the value of the at least one parameter of the at least one first device, depending on the activity obtained.

2. The method of claim 1, further comprising receiving the data representative of the behavior of the first user, wherein obtaining a current activity of the first user comprises determining the activity of the first user.

3. The method of claim 1, further comprising identifying the at least one first device.

4. The method of claim 1, further comprising obtaining means for accessing the at least one first device.

5. The method of claim 1, further comprising determining a value of at least one parameter of the at least one first device to be modified.

6. The method of claim 5, further comprising:
obtaining a current value of the at least one parameter of the first device, and
triggering the transmission of the instruction intended to modify the value of the at least one parameter of the at least one first device upon a determination that the current value obtained is different from the determined value.

7. The method of claim 1, wherein the at least one parameter of the device is a parameter representative of an interaction modality.

8. The method of claim 1, further comprising obtaining a current activity of at least one second user different from the first user, the activity of the at least one second user being determined depending on data representative of the behavior of the second user in said environment, wherein the value of at least one parameter of the first device to be modified is determined depending on the activity of the at least one second user.

9. The method of claim 1, wherein the instruction is transmitted to a plurality of first devices located at a predetermined distance from the first user.

10. The method of claim 1, wherein the instruction is transmitted to a mobile device of the first user.

11. The method of claim 1, wherein the transmitted instruction comprises a data representative of a duration during which the at least one parameter of the at least one first device must consider the modified value.

12. The method of claim 1, wherein the method implemented by a second device different from the first device, such as a gateway, and wherein the instruction intended to modify the value of at least one parameter of the first device is transmitted by the second device and to the first device.

13. The method of claim 12, wherein the second device comprises a gateway.

14. The method claim 12, wherein the transmission is triggered in response to the receipt, by the second device, of a verification request from the first device.

15. An electronic device configured to modify a value of at least one parameter of at least one first device, the electronic device comprising a processor, the electronic device configured to:
obtain a current activity of a first user depending on data representative of the behavior of the first user in an environment including at least one connected object, the data being captured by the at least one connected object; and,
transmit an instruction intended to modify the value of the at least one parameter of the at least one first device, depending on the activity obtained.

16. A non-transitory computer-readable recording medium having stored thereon instruction which, when implemented by a processor, causes the processor to implement the method of claim 1.
